(19) United States
(12) Patent Application Publication
(10) Pub. No.: US 2005/0141542 A1
(43) Pub. Date: Jun. 30, 2005

(54) Personnalization module for interactive digital television system

(75) Inventors: Koen Handekyn, Gent (BE); Marc Bruno Frieda Godon, Londerzeel (BE); Lieven Leopold Albertine Trappeniers, Herentals (BE); Hendrik Eugene Irene Nicolas Dacquin, Gent (BE); Rony Alfons Maria Baekeland, Antwerp (BE); Jan Alfons Albert Bouwen, Antwerp (BE); Toon Coppens, Lier (BE); Arjen Hendrikse, Brussel (BE); Sigurd Van Broeck, Zoersel (BE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/991,835

(22) Filed: Nov. 19, 2004

(30) Foreign Application Priority Data
Nov. 20, 2003 (EP) 03292890.5
Aug. 6, 2004 (EP) 04292005.8

(51) Int. Cl. G08C 17/00

(52) U.S. Cl. 370/437

(57) ABSTRACT

An interactive digital television system (iDTV) with a personalization module (PM) for injecting signals towards a small user-groups. The iDTV system comprises a broadcast operator (BO) for sending to subscriber units (SB: SB₁-SB₃) a downstream digital broadcast stream (BS) received from an interactive digital television provider (ITVP), and also comprising an interaction return channel operator (RCO) for providing interactivity between the subscriber units and the interactive digital television provider by means of a bi-directional interaction return channel (IC). The personalization module (PM) is coupled to the bi-directional interaction return channel (IC) and allows intercommunication between the subscriber units. As a result, a user can escape the limitations of the current linear TV programs and is transformed from a pure spectator into a producer and director of a collective or individual iDTV experience. In this way, when implicit or explicit groups of users are created, a user of the group may send control or data signals to the other users of the group. Data signals may be multimedia data to display and control signals may be recommendations of switching all together to another broadcasted channel. Preferably, each subscriber unit comprises a set-top box (STB) coupled to a server-side logic (L₁) of the interactive digital television provider (ITVP) via the personalization module (PM) and this personalization module comprises an application logic proxy (L₁′) able to interpret signals sent over the interaction return channel (IC) between the set-top box and the server-side logic in order to forward selected ones of these signals to other parts of the iDTV system. The personalization module (PM) comprises some or all the following modules: the application logic proxy (L₁′), a content-reflector and forking module (L₂), a community support module (L₃), a presence module (L₄), a terminal capability module (L₅) and a broadcast data collector module (L₆), interconnected through a routing/forwarding layer or link (RFL).

The present invention relates to an interactive digital television system comprising a broadcast operator adapted to send towards a plurality of subscriber units a downstream digital broadcast stream selected amongst a plurality of broadcast signals received from interactive digital television providers, and an interaction return channel operator adapted to provide interactivity between said plurality of subscriber units and said interactive digital television provider by means of bi-directional interaction return channels.

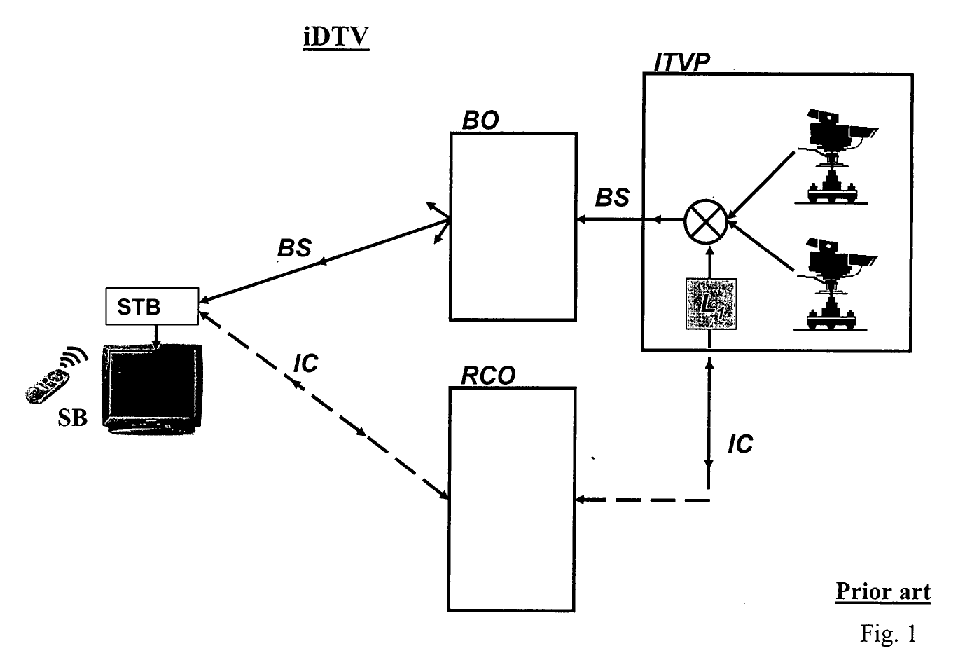

Such an interactive Digital TeleVision iDTV system, as shown at FIG. 1, is generally known in the art. The iDTV system contains an interactive Digital TeleVision provider ITVP, hereafter also called iDTV provider, and adapted to send a downstream digital broadcast stream BS, containing a combination of a digital video signal and program logic, to the broadcast operator BO. The broadcast operator broadcasts the digital stream BS to the subscriber units, e.g. SB. At each subscriber unit, the stream BS is decomposed into a video signal and program logic. The known interactive Digital Television system iDTV provides interactivity through the bi-directional interaction return channel IC via the return channel operator RCO. As a result, the following applications can be supplied: online voting, moderated (broadcasted) message boards, switch camera & viewpoint, transpositions of internet services like e-mail, (AOL) instant messaging on TV broadcasts, . . . .

However, the known iDTV system doesn't offer integrated support for small user groups, user-presence indication nor the possibility of modifying or injecting content, e.g. personal content by the user of a subscriber unit SB. Currently each user or viewer of a broadcast stream has to take individually action to switch broadcast channel or to get any other kind of information, e.g. from another user. There is no support for advised, forced or synchronized switching of broadcast channels or receiving additional information. At most, the known system transposes Internet technologies, like instant messaging, to iDTV.

An object of the present invention is to provide an interactive digital television system of the above known type but which is adapted to integrate support for small user groups, to support user-presence indications and to allow for injecting personal content by a user and/or channel switching control.

According to the invention, this object is achieved due to the fact that said interactive digital television system further comprises a personalization module coupled to said bi-directional interaction return channels and adapted to allow intercommunication between subscriber units of said plurality.

In this way, the users of the subscriber units are allowed to communicate and exchange information with each other through the personalization module. In other words, the user of a subscriber unit can escape the limitations of the current linear TV programs and is transformed from a pure spectator into a producer and director of a collective or individual iDTV experience.

Another characterizing embodiment of the present invention is that said television system further comprises a community support module adapted to receive and to handle information about said subscriber units and to setup and maintain user groups constituted by subscriber units of said plurality.

The community support module knows about the users, user-groups and privacy preferences, this module can add or delete members or buddies to user groups and also setup and modify user groups based on implicit or on explicit information. Owing to this community support module, the community of users can be managed by the end-users themselves: they can add new buddy's, etc. and control the accesses. Users matching predetermined characteristic can also be automatically integrated in a particular user group, as it will become clear later.

In a preferred characterizing embodiment of the present invention, said community support module is comprised in said personalization module.

There is however no need for the community support module to be included in the personalization module for collecting the preferences of the users of the subscriber units.

Also another characterizing embodiment of the present invention is that said personalization module further comprises a presence module adapted to handle information about the status of said subscriber units and their links to other telecommunication facilities.

The presence module contains knowledge about presence of users on the subscriber units, about what the users are doing, and about the existing links, e.g. to Intelligent Networks, Instant Messaging systems or the like. The presence module may also contain technical information concerning the subscriber units.

Still another characterizing embodiment of the present invention is that said personalization module further comprises a terminal capability module adapted to receive information from said community support module and from said presence module and to control the operation of a content-reflector and forking module also comprised in said personalization module.

This terminal capability module will advice the content-reflector and forking module of the possibility, modalities and necessary transformations for sending control or data signals to the subscriber units. The known iDTV architectures do not allow other actors, as for instance the interaction return channel operator, to take up responsibility in providing iDTV functions. This can however be done, for instance by a user, through the operation of the terminal capability module and the content-reflector and forking module.

Owing to the personalization module, the end-user is empower to actively contribute to an iDTV experience by sharing multimedia content, such as movies, real-time video streams, voice, text, pictures, messaging, with a small group of buddies while collectively experiencing an iDTV application. The shared content may be personal content of a user or content broadcasted by the iDTV provider. A user may, for instance, be invited (or forced) to join the “swarming” of other users to switch to another broadcast channel. The terminal capability module advises this “swarm” of users of a same group, based on, e.g., common interest or users with a same profile.

The present invention is further also characterized in that said content-reflector and forking module is adapted to reflect to at least one subscriber unit of a particular user group, signals received from another subscriber unit belonging to said particular user group. The signals reflected by said content-reflector and forking module are either data signals or control signals.

The content-reflector and forking module receives data or control signals from a user, generally via other modules of the television system. If the received signals are data, the content-reflector and forking module reflects and duplicates (forks) these data signals to some or all members of a user group that are participating to a same iDTV experience. In other words, the content-reflector and forking module then allows “content injection” from a particular user to other users. If the received signal is a control signal, the content-reflector and forking module forwards the control to some or all members of a user group to recommend, to request or to force them to switch from broadcast channel. Anyway, this new embodiment empowers the users to personalize the interactive part of the iDTV experience, resulting in a higher perceived added-value.

Also in a preferred characterizing embodiment of the present invention, said presence module (L₄) is adapted to receive from said one subscriber unit (SB₂, SB₃) instructions indicating whether said one subscriber unit (SB₂, SB₃) wants to receive said signals unconditionally or only according to predetermined conditions.

In case the receiving users have decided to receive unconditionally the signals, these users of the group will all watching the same multimedia content or will all switch collectively to another channel. In case of predetermined conditions are set, the collective operation is subjected e.g. to a vote with a majority decision.

The present invention thus enables a user to join a “swarming” of users zapping across the broadcast channels. The system advises the receiving user on which “swarm of similar users” to join, based on for example common interests or profiles.

Also another characterizing embodiment of the present invention is that said interactive digital television system further comprises a broadcast data collector module (L₆) adapted to receive broadcasting information from said interactive digital television providers (ITVP), and that said personalization module (PM) further comprises a terminal capability module (L₅) adapted to receive information from said community support module (L₃), from said presence module (L₄), and from said broadcast data collector module (L₆), and to generate thereby channel selection signals.

Another advantage of the possibility to supervise the content injection, presence, buddy list, . . . switching control functions, is that the iDTV providers can also contribute by offering not only their core expertise: transport and enhanced communication services (presence, buddy list, personalization, billing, . . . ), but also suitable data broadcasting at appropriate time schedules.

Again in a preferred characterizing embodiment of the present invention, each subscriber unit (SB: SB₁-SB₃) of said plurality comprises a set-top box (STB: STB₁-STB₃), and said terminal capability module (L₅) is adapted to transmit said channel selection signals to the a set-top boxes of subscriber units (SB: SB₁-SB₃) belonging to a same predetermined user group.

In this way, the above decision for a user to join a “swarming” of users zapping across the broadcast channels or receiving the same multimedia data may be taken by the user at the level of his set-top box rather than providing conditional instructions to the presence module as mentioned above.

Another characterizing embodiment of the present invention is that each subscriber unit of said plurality comprises a set-top box coupled to a server-side logic of said interactive digital television provider via said personalization module, and that said personalization module comprises an application logic proxy adapted to interpret signals sent over said interaction return channel between said set-top box and said server-side logic in order to forward selected ones of said signals to other parts of said interactive digital television system.

The application logic proxy is a front-end for the server-side logic of the iDTV provider. This proxy extracts and filters-out signals that may be needed, e.g., to allow users of the subscriber units to communicate with each other or to control their channel switching, while it can also forward signals from the subscriber units to the server-side logic, and vice versa.

Also another characterizing embodiment of the present invention is that said interaction return channel is a broadband Digital Subscriber Line, e.g. ADSL.

Further characterizing embodiments of the present interactive Digital TeleVision system iDTV are mentioned in the appended claims.

It is to be noticed that the term ‘comprising’, used in the claims, should not be interpreted as being restricted to the means listed thereafter. Thus, the scope of the expression ‘a device comprising means A and B’ should not be limited to devices consisting only of components A and B. It means that with respect to the present invention, the only relevant components of the device are A and B.

Similarly, it is to be noticed that the term ‘coupled’, also used in the claims, should not be interpreted as being restricted to direct connections only. Thus, the scope of the expression ‘a device A coupled to a device B’ should not be limited to devices or systems wherein an output of device A is directly connected to an input of device B. It means that there exists a path between an output of A and an input of B which may be a path including other devices or means.

The above and other objects and features of the invention will become more apparent and the invention itself will be best understood by referring to the following description of an embodiment taken in conjunction with the accompanying drawings wherein:

FIG. 1 shows an interactive Digital TeleVision [iDTV] system as known from the prior art;

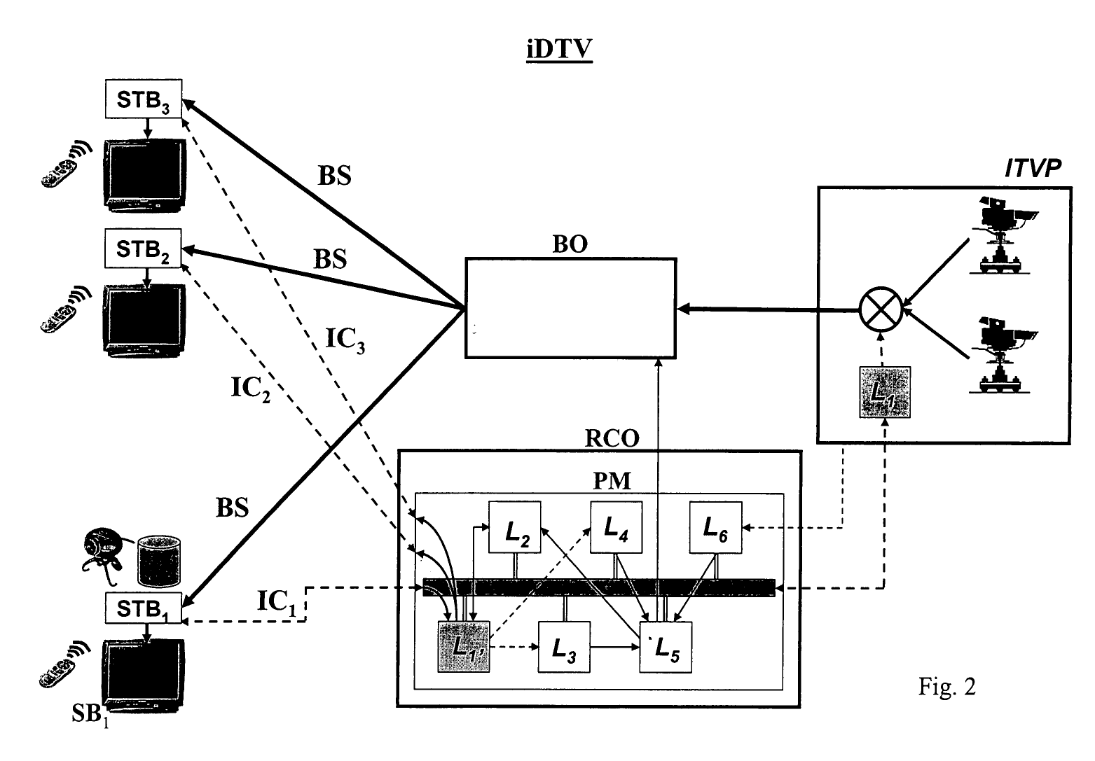

FIG. 2 represents an interactive Digital TeleVision [iDTV] system according to the invention with a personalization module (PM) in the return channel operator (RCO);

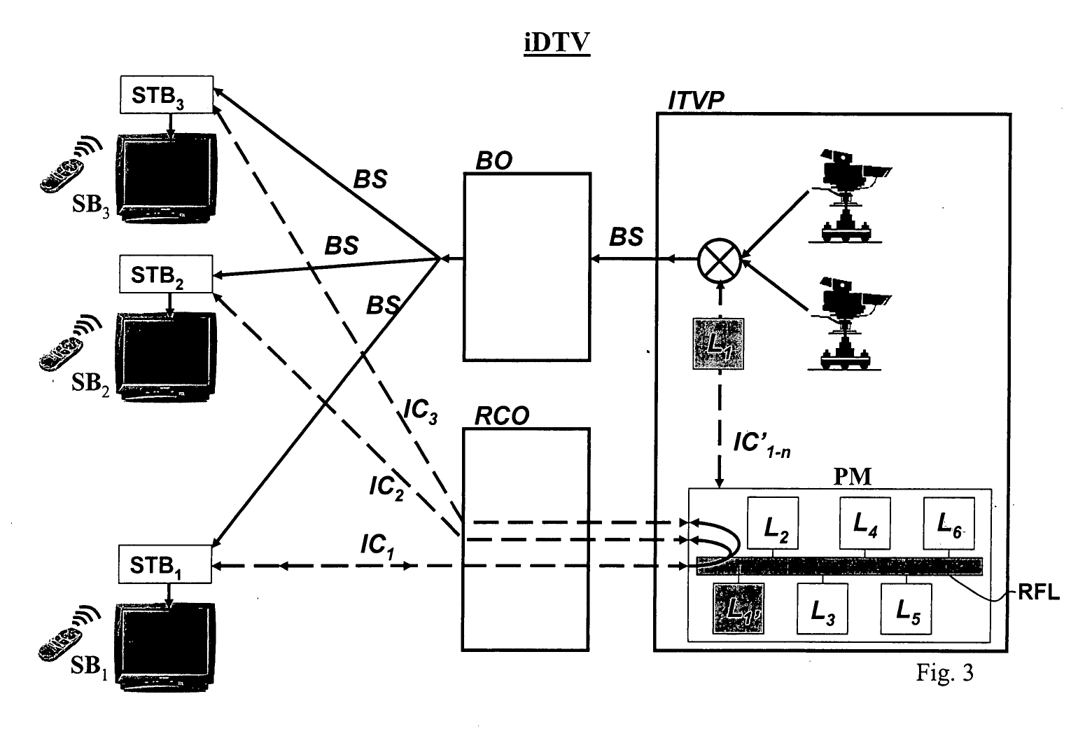

FIG. 3 represents a variant of the interactive Digital TeleVision [iDTV] system of FIG. 2 with the personalization module (PM) in the interactive Digital TeleVision [iDTV] provider; and

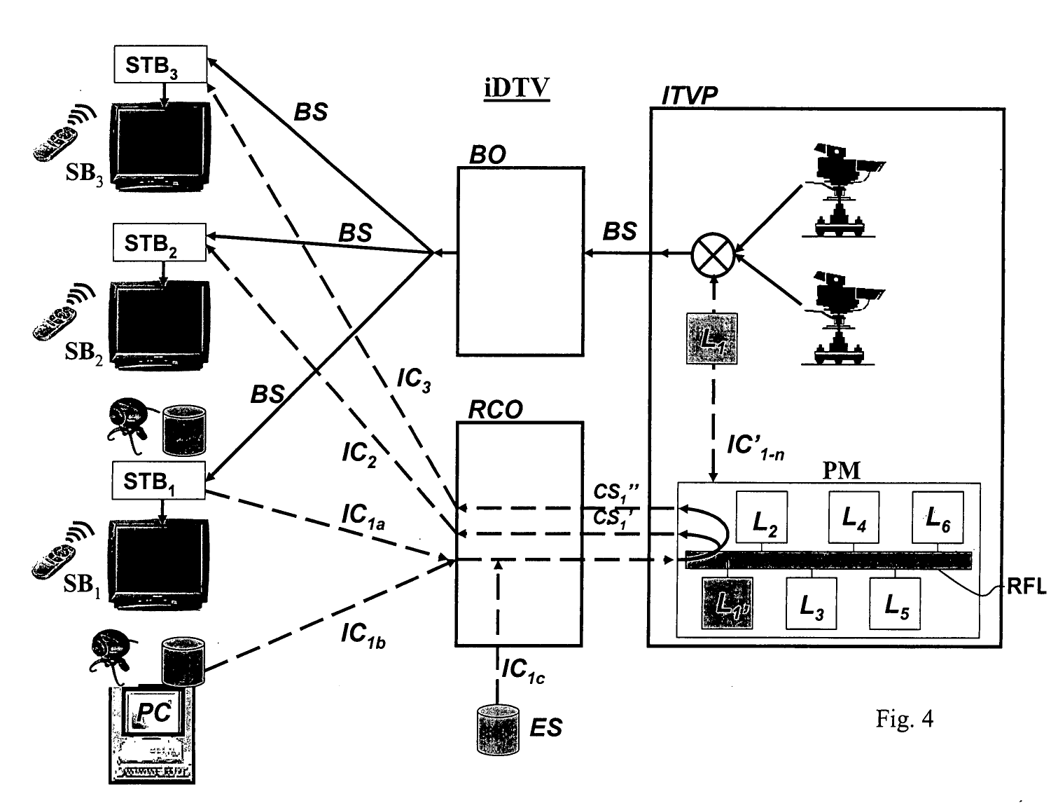

FIG. 4 shows an example of content injection in the interactive Digital TeleVision [iDTV] system of FIG. 3.

The interactive Digital TeleVision system iDTV shown at FIG. 1 is already known in the art. It comprises an interactive Digital TeleVision provider ITVP, hereafter also called iDTV provider, adapted to send a downstream digital broadcast stream BS to a broadcast operator BO. The digital broadcast stream BS contains a combination of a digital video signal and program logic. The broadcast operator BO broadcasts the digital stream to subscriber units, such as SB, either by satellite, cable, terrestrial broadcasting or over a broadband Internet infrastructure (possibly Internet Protocol IP) like ADSL, VDSL, . . . , i.e. Digital Subscriber Lines [DSL]. Each subscriber unit SB has a digital Set-Top Box STB that decomposes the stream BS into the video signal and the program logic. The program logic is executed on the set-top box and allows the user of a subscriber unit to interact. The combination of the video stream and graphical elements of the user consuming (interacting with) the program logic is then sent to the television set of the subscriber unit for visualization. It is to be noted that the subscriber unit may comprise the set-top box, a television set TV, a Personal Computer PC, a webcam, and/or any other multimedia device.

The interactive Digital Television system iDTV provides interactivity by means of a bi-directional interaction return channel IC. This interaction return channel IC, provided by an interaction return channel operator RCO, can be narrowband dial-up, broadband DSL, leased-line, wireless, Internet Protocol IP, non-IP, . . . . The interaction return channel operator RCO is transparent for the bi-directional interaction return channel IC; the interaction return channel operator RCO only provides transport and is coupled between the iDTV provider ITVP and the subscriber units.

The interaction return channel IC is terminated at the iDTV provider ITVP by a server-side logic L₁ that is adapted to interpret the upstream signals sent by the set-top box STB over the interaction return channel IC. This network-side counterpart L₁ of the program logic that is executing on the set-top box is able to influence both the video and the logic component of the downstream broadcast BS and can also send information back to the user over the unicast part of the interaction return channel IC. The server-side counterpart L₁ of the program or application logic takes care of interaction with the user of a subscriber unit and a video-mixer at the iDTV provider.

It is to be noted that the digital broadcast stream BS and the bidirectional interaction return channel IC can be transmitted over a same link, e.g. VDSL, or a combination of different links, e.g. Satellite for the digital broadcast stream BS and ADSL for the interaction return channel IC.

Additionally to the above-mentioned items, the interactive Digital TeleVision system iDTV of the present invention comprises a personalization module PM as shown at FIG. 2. The personalization module PM coupled to the bi-directional interaction return channel IC and is adapted to allow intercommunication between subscriber units SB, such as SB₁, SB₂ and SB₃. PM may be located at the return channel operator RCO (as shown at FIG. 2), at the iDTV provider ITVP (as shown at FIG. 3), at the iDTV broadcast operator BO or at a combination of these.

As will be explained below, implicit and/or explicit groups of users are created. Owing to different modules possibly but not obligatory located in the personalization module PM, a user of a group may send control or data signals to the other users of the group. Data signals may be multimedia data to ear and/or to display, and control signals may be recommendations to all the users of a group for switching to another broadcasted channel.

To achieve these facilities, the personalization module PM comprises some or all the following modules:
an application logic proxy L₁′,
a content-reflector and forking module L₂,
a community support module L₃,
a presence module L₄,
a terminal capability module L₅, and
a broadcast data collector module L₆
   preferably interconnected through a routing/forwarding layer or link RFL that distributes and forwards signals arriving/leaving over the interaction return channels IC to/from the modules L′₁-L₆.

The application logic proxy L₁′ is a front-end for the known application logic L₁ that stays under the responsibility of the iDTV provider. The proxy L₁′ extracts, and possibly filters-out, the signals that are needed by the modules L₁-L₄ and forwards unrelated signals, like for example a pan/tilt signal for a ITVP camera.

The community support module L₃ knows about users, user-groups and privacy preferences, this module may be (partly) managed by the end-users, they can add or delete members or buddies to user groups and also setup new user groups. The community support module L₃ is in fact a user profiles and events collector and profiler that collects relevant information and events (actions) provided by the user. These comprise keywords, preferences, interests, history of viewed broadcasts, summary of shared content, . . . . The module L₃ can construct profiles from analyzing these data and relate these profiles to groups of users having similar characteristics and maintains so explicit or implicit groups. Explicit groups are groups of users managed by the end users themselves. The so-called buddy list is an example of such a user-managed group. Implicit groups result out of a profile matching with some set of rules applied. A user profile can have real-time properties, for example with respect to his zapping behavior. By “zapping” is meant connecting to “content”, i.e. to select a broadcast channel, to select a stream, to connect to a content network, etc. By extension, a user can also “zap” to “personal broadcast channels”, i.e. connect to data made available by another user, the content source then comprises personal broadcast channels, i.e. dynamic content sources offered by individual peer users.

It is to be noted that a user can belong to a set of possibly mixed implicit or explicit communities and can be part of multiple user groups.

The community support module L₃ needs to be coupled, at least periodically, to the user in order to collect information thereof. However, L₃ is not obligatory located in the personalization module PM.

The presence module L₄ contains the knowledge about presence of all iDTV users based on information of their set-top box, such as:
is the user watching TV?
which channel?
is he linked to Intelligent Networks?
are Instant Messaging systems available?
does he wants to join the “swarming” of other users to switch to another broadcast channel, if he is invited (or forced)?
under what conditions does he wants to join: after majority voting, unconditionally, else . . . ?

The switch request to another content (broadcasted channel or personal data provided by a user) can result into anything between a forced switch where the user's channel is changed without any interaction by the end user himself, or an on-screen switch proposal. Somewhere in between, the switch request can require that first a consultation/negotiation phase with the user(s). Several decision rules for voting can be selected: unanimous where everyone has veto right, majority where at least half of the people agree, etc.

In other words, a zap request within a community can be one of the following:
zap recommendation: the user is presented a recommendation to zap to a specific channel. On acknowledgement he is switched towards the proposed content;
zap request with voting module: the whole of the community is proposed to move to another channel. All of the members can vote for the move. The presence module L₄ then acts as a zapper voting module that handles the voting and depending on the result, the community will connect to the proposed channel. This voting can be realized according to different voting strategies: by veto, by consensus, by majority, etc.; and
auto-zap, also called follow mode or slave mode: the user is “following” the zap behavior of another individual or of a community or the zap proposals by the zap recommendation engine.

It is to be noted that the channel switching also applies to the case where the set-top-box is the ‘channel’ selector, in the user's house.

The terminal capability module L₅ receives information from the community support module L₃ and from the presence module L₄. L₅ is an engine that analyses the user profile (possibly including real-time properties) and decides what to do with the content currently offered by the different content providers.

The terminal capability module L₅ is further coupled to a broadcast data collector module L₆ which receives broadcasting information from the interactive digital television providers ITVP. In more detail, L₆ is a broadcast (meta-) data collector module also called channel management module that collects relevant information about the broadcast. This comprises keywords, subject, category, director, location, time-stamp, weather conditions, producer, actors, summary, . . . . This broadcast information can originate either from the broadcaster, a broadcast-stream processor extracting meta-information embedded in the broadcast video-stream, or even from a third party (multimedia encyclopedia). Owing to the broadcast data collector module L₆, the terminal capability module L₅ is aware about the content currently available on the content network, broadcast channels, etc and can advise about a “swarm” of users of a same group, based on, e.g., common interest or users with a same profile.

In co-operation with the community module L₃, the presence module L₄ and the broadcast data collector module L₆, from which it receives information, the terminal capability module L₅ controls the content-reflector and forking module L₂. The latter module L₂ receives, reflects and duplicates (forks) streams of personal or broadcast content from a user or from the television providers ITVP to all or part of online members of a community that are participating to a same iDTV experience. As already mentioned, data content may be movies, real-time audio/video streams, voice, text, pictures, messaging, data, meta-data, . . . , whilst control content may be recommendations to zap.

The content-reflector and forking module L₂ may thus be seen as a content switcher or a zapper execution engine that executes—triggered by the rules engine L₅, itself controlled by L₃, L₄ and L₆—the switch to a (broadcast, personal, etc.) predetermined channel or personal data.

In co-operation, the community module L₃, the presence module L₄, the broadcast data collector module L₆ and the terminal capability module L₅:
match broadcast-content's (meta-) data and user profiles;
match user profiles with profiles of user-population;
apply a rule-set on broadcast content; and
apply a rule-set on user and community events & properties.

The community defines and manages the access roles to the rule set executed (or to be executed) by the assigned rules engine to the community. The rule set can be activated and modified (e.g. by a designated role in the community). Rules can applied on several elements like properties of the members of the community, on properties of their interest, on properties of the content broadcasted via the channels or categories, on properties of broadcaster agenda information, etc.

It is further to be noted that the modules L₃ and L₄ can work in a several modes: they can receive and store all the data from the different sources, they can lookup the required data when needed directly from the sources, the Internet, a peer-to-peer network, etc.

In an example to illustrate the operation of the present interactive digital television system iDTV, and referring to FIG. 2, a content stream from the subscriber unit SB₁ arrives over an interaction return channel IC₁ at the content reflector and forking module L₂ of the personalization module PM. This stream is forked into two content streams send to two buddies SB₂ and SB₃ using interaction return channels IC₂ and IC₃ respectively. The application logic on the set-top boxes STB₁-STB₃ adds this content to the displayed stream BS from the broadcast operator BO.

As already mentioned, the scope of users that (can) receive the content that is injected by a user, e.g. SB₁, is determined by the membership of a community combined with the preference of these users. A user can for example also select a subset of a community for certain content injections.

It is to be noted that technically the broadcast stream BS could also be used to convey a limited number of “private” streams.

It is also to be noted that a possible embodiment of the reflector could limit itself to distributing the knowledge about the connectivity of STB's buddies, members of a particular group, to all STB's such that the actual distribution of the content can be done by known multicast or peer-to-peer techniques, for instance by means of Internet Protocol IP.

The interaction return channel IC as well as the broadcast channel BS may not have enough capacity to support an application. The bandwidth may depend on the location and operator used by one of the buddies. Therefore, a terminal capability module L₅, has been added as extension to the iDTV architecture: This module L₅ will advice module L₂ of the possibility, modalities and necessary transformations for sending a stream of content to a set-top box, e.g. can the set-top box accept incoming streams and if yes, at what rate?

It is to be noted that this capability information and function will typically reside at the broadcast operator BO or at the interaction return channel operator RCO. The interactive digital television provider ITVP will not take care about this problem.

It is also to be noted that partial scenarios in which only a subset of the modules L₁-L₆ are involved are also possible. This means that all the modules L₁ to L₆ don't need to be simultaneously present in the personalization module PM.

In a variant embodiment of the present interactive digital television system iDTV, shown at FIG. 3, the modules L₁-L₆ are located at the iDTV provider ITVP rather than at the return channel operator RCO as described above. In other possible variants, these modules L₁-L₆ may also be located at the iDTV broadcast operator BO or spread over these parts RCO, ITVP and BO. Also different actors can take up the roles of RCO, ITVP and BO or a specific party can take up several roles. For example, a same cable-company can take up the roles of both the iDTV broadcast operator BO and the interaction return channel operator RCO.

As an example, in the interactive digital television system iDTV, shown at FIG. 4, a personal content is injected. This content may be originated from the set-top box STB₁ of the subscriber unit SB₁. It is then for instance a video fragment that was recorded earlier on a hard disk of the set-top box STB₁, a video stream from an attached camera, an audio stream from an attached microphone, a text chat, . . . transmitted via the interaction return channels IC₁ₐ. It may also come from a Personal Computer PC providing views of a web cam or movies, a picture, sound, music, data from its hard disk, and transmitted via the interaction return channels IC_{1b}; or it may transmitted via the interaction return channels IC_{1c} and come from an external storage server ES coupled to the network and containing either personal content of the user or third party content to which the user gives a URL.

When the user of the subscriber unit SB₁, hereafter called user SB₁, switches-on his TV, he sees that some of his friends, users SB₂ and SB₃, are watching a sports event. User SB₁ then joins the football channel and uses iDTV on his set-top box STB₁ for on-screen chatting with his group of friends SB₂ and SB₃, shielded from the other viewers of the broadcast. While chatting, user SB₁ wants to share an interesting movie-clip that shows a sportsman doing an impressive performance at an earlier event. The movie-clip of user SB₁ streams from the hard disk of his set-top box STB₁ over the interaction return channel IC₁ₐ to the media reflector module L₂. This module L₂ duplicates the stream and sends it to the set-top boxes STB₂ and STB₃ of the online friends SB₂ and SB₃ only. To this end, the media reflector module L₂ co-operates with the community module L₃ and the presence module L₄, all under control of the terminal capability module L₅. Alternatively, the movie-clip, showing the sportsman doing the performance at an earlier event, could also originate from the PC of user SB₁ or from a file from the external server ES to which user SB₁ gives a reference, for example under the form of a URL.

In another example of the application, the user of the subscriber unit SB₂ starts watching an educational movie for a school-assignment. He notices that some friends have already switched to the school-TV channel. While watching the educational movie, this sub-group of users, e.g. students, may video-chatting on-screen using iDTV. In the background, the modules L₁-L₅ are doing the video-chat communication functionalities for them.

The iDTV director and producer do not have to bother that the iDTV provider has to provide the infrastructure for modules L₁-L₆. They can put placeholders for these functions (user-groups, buddies, presence, content forking and forwarding, . . . ) in their programs that will look for the proper instantiations of these functions. A suitable mechanism for this can be found in known web-services technology. The advantage of this possibility to delegate these functions is that the iDTV provider can focus on his core business: create and broadcast iDTV programs. Moreover, the iDTV broadcast operators, e.g. cable companies, and iDTV interaction return channel operators, e.g. telecom operator providing ADSL, can also contribute, and even make profit, by offering their core expertise: transport and enhance communication services, i.e. presence, buddy-list, personalization, billing, . . . .

Also in another example of the application, a group of users can initiate a switch of TV channel as a result of a discussion via communication over a separated channel (voice, video, VIP, etc.). The users of the group are for example all watching a tennis match. However, this match is getting pretty boring as it is becoming extremely clear that a certain player will win. One of the users notices that a specific episode of “XYZ” is going to start on another channel. A switch will be proposed to all the other members of the group and these members can follow the zapping to the other channel.

Users interested in the TV series “ZYX” can for instance start a community. Using the broadcast data collector module L₆, the assigned rules engines will scan all channels, broadcast programs, and proposes an agenda for the evening or the upcoming days. On the appropriate time the channel manager will recommend a switch for the online members.

An advantage of the proposed interactive digital television system is that television spectators can follow each other in their interest and preferences. For example watching television together becomes a more interesting and memorable experience. This system enables “swarming” of users across contents (personal data, network channels, etc). It will result in a mode where the communities are defined implicitly and the zapper execution engine runs in a recommendation mode.

A final remark is that embodiments of the present invention are described above in terms of functional blocks. From the functional description of these blocks, given above, it will be apparent for a person skilled in the art of designing electronic devices how embodiments of these blocks can be manufactured with well-known electronic components. A detailed architecture of the contents of the functional blocks hence is not given.

While the principles of the invention have been described above in connection with specific apparatus, it is to be clearly understood that this description is merely made by way of example and not as a limitation on the scope of the invention, as defined in the appended claims.

1. An interactive digital television system (iDTV) comprising
a broadcast operator (BO) adapted to send towards a plurality of subscriber units (SB: SB₁-SB₃) a downstream digital broadcast stream (BS) selected amongst a plurality of broadcast signals received from interactive digital television providers (ITVP), and
an interaction return channel operator (RCO) adapted to provide interactivity between said plurality of subscriber units and said interactive digital television provider by means of bi-directional interaction return channels (IC₁, IC₂, IC₃),
characterized in that said interactive digital television system further comprises a personalization module (PM) coupled to said bi-directional interaction return channels (IC₁, IC₂, IC₃) and adapted to allow intercommunication between subscriber units (SB: SB₁-SB₃) of said plurality.

2. The interactive digital television system according to claim 1, characterized in that said television system further comprises a community support module (L₃) adapted to receive and to handle information about said subscriber units (SB: SB₁-SB₃) and to setup and maintain user groups constituted by subscriber units of said plurality.

3. The interactive digital television system according to claim 2, characterized in that said community support module (L₃) is comprised in said personalization module (PM).

4. The interactive digital television system according to claim 1, characterized in that said personalization module (PM) further comprises a presence module (L₄) adapted to handle information about the status of said subscriber units (SB: SB₁-SB₃) and their links to other telecommunication facilities.

5. The interactive digital television system according to claim 2, characterized in that said personalization module (PM) further comprises a presence module (L₄) adapted to handle information about the status of said subscriber units (SB: SB₁-SB₃) and their links to other telecommunication facilities, and further characterized in that said personalization module (PM) further comprises a terminal capability module (L₅) adapted to receive information from said community support module (L₃) and from said presence module (L₄) and to control the operation of a content-reflector and forking module (L₂) also comprised in said personalization module (PM).

6. The interactive digital television system according to claim 5, characterized in that said content-reflector and forking module (L₂) is adapted to reflect to at least one subscriber unit (SB₂, SB₃) of a particular user group, signals received from another subscriber unit (SB₁) belonging to said particular user group.

7. The interactive digital television system according to claim 6, characterized in that the signals reflected by said content-reflector and forking module (L₂) are data signals.

8. The interactive digital television system according to claim 6, characterized in that the signals reflected by said content-reflector and forking module (L₂) are control signals.

9. The interactive digital television system according to claim 6, characterized in that said presence module (L₄) is adapted to receive from said one subscriber unit (SB₂, SB₃) instructions indicating whether said one subscriber unit (SB₂, SB₃) wants to receive said signals unconditionally or only according to predetermined conditions.

10. The interactive digital television system according to claim 2,
characterized in that said personalization module (PM) further comprises a presence module (L₄) adapted to handle information about the status of said subscriber units (SB₁-SB₃) and their links to other telecommunication facilities,
and in that said interactive digital television system further comprises a broadcast data collector module (L₆) adapted to receive broadcasting information from said interactive digital television providers (ITVP),
and in that said personalization module (PM) further comprises a terminal capability module (L₅) adapted to receive information from said community support module (L₃), from said presence module (L₄), and from said broadcast data collector module (L₆), and to generate thereby channel selection signals.

11. The interactive digital television system according to claim 10, characterized in that said broadcast data collector module (L₆) is comprised in said personalization module (PM).

12. The interactive digital television system according to claim 10,
characterized in that each subscriber unit (SB: SB₁-SB₃) of said plurality comprises a set-top box (STB: STB₁-STB₃),
and in that said terminal capability module (L₅) is adapted to transmit said channel selection signals to the a set-top boxes of subscriber units (SB: SB₁-SB₃) belonging to a same predetermined user group.

13. The interactive digital television system according to claim 12, characterized in that the channel selection signals are first transmitted from the terminal capability module (L₅) to a content-reflector and forking module (L₂) adapted to duplicate said channel selection signals prior to transmit them to the subscriber units (SB: SB₁-SB₃) belonging to said predetermined user group.

14. The interactive digital television system according to claim 10, characterized in that said terminal capability module (L₅) is adapted to transmit said channel selection signals to said broadcast operator (BO) for sending a predetermined downstream digital broadcast stream (BS) to subscriber units (SB: SB₁-SB₃) belonging to a same predetermined user group.

15. The interactive digital television system according to claim 1,
characterized in that each subscriber unit (SB: SB₁-SB₃) of said plurality comprises a set-top box (STB: STB₁-STB₃) coupled to a server-side logic (L₁) of said interactive digital television provider (ITVP) via said personalization module (PM),
and in that said personalization module (PM) comprises an application logic proxy (L₁′) adapted to interpret signals sent over said interaction return channels (IC₁, IC₂, IC₃) between said set-top box and said server-side logic in order to forward selected ones of said signals to other parts of said interactive digital television system (iDTV).

16. The interactive digital television system according to claim 5, characterized in that said other parts of said interactive digital television system (iDTV) are said content-reflector and forking module (L₂), said community support module (L₃) or said presence module (L₄).

17. The interactive digital television system according to claim 16, characterized in that the application logic proxy (L₁′), the content-reflector and forking module (L₂), the presence module (L₄) and the terminal capability module (L₅) all interconnected in said personalization module (PM) by means of a routing/forwarding link (RFL).

18. The interactive digital television system according to the claim 17, characterized in that said community support module (L₃) is comprised in said personalization module (PM), and in that the community support module (L₃) is coupled to said routing/forwarding link (RFL).

19. The interactive digital television system according to claim 17, characterized in that said content-reflector and forking module (L₂) is adapted to reflect to at least one subscriber unit (SB₂, SB₃) of a particular user group, signals received from another subscriber unit (SB₁) belonging to said particular user group, and in that said presence module (L₄) is adapted to receive from said one subscriber unit (SB₂, SB₃) instructions indicating whether said one subscriber unit (SB₂, SB₃) wants to receive said signals unconditionally or only according to predetermined conditions, and in that the broadcast data collector module (L₆) is coupled to said routing/forwarding link (RFL).

20. The interactive digital television system according to claim 18, characterized in that at least one constituent part of said personalization module (PM) is located in said interaction return channel operator (RCO).

21. The interactive digital television system according to claim 18, characterized in that at least one constituent part of said personalization module (PM) is located in said interactive digital television provider (ITVP).

22. The interactive digital television system according to claim 1, characterized in that said interaction return channel (IC) is a broadband Digital Subscriber Line (DSL).
